(19) United States
(12) Patent Application Publication
(10) Pub. No.: US 2023/0060855 A1
(43) Pub. Date: Mar. 2, 2023

(54) PROCESSOR CIRCUIT AND NON-TRANSITORY COMPUTER READABLE MEDIUM

(71) Applicant: REALTEK SEMICONDUCTOR CORPORATION, HSINCHU (TW)

(72) Inventor: HAN-CHIEH HSIEH, HSINCHU (TW)

(21) Appl. No.: 17/840,839

(22) Filed: Jun. 15, 2022

(30) Foreign Application Priority Data
Aug. 30, 2021 (TW) 110132095

(51) Int. Cl. G06N 3/04

(52) U.S. Cl. CPC G06N 3/04

(57) ABSTRACT

A processor circuit includes a processor, N detection circuits and a neural network circuit. The processor is configured to provide a control signal. The control signal indicates an operational status of the processor. The N detection circuits are configured to detect N different types of variation factors affecting an operating voltage of the processor respectively, and accordingly generate N detection results respectively. N is an integer greater than one. The neural network circuit, coupled to the processor and the N detection circuits, is configured to determine the operating voltage of the processor according to the control signal and the N detection results.

### CROSS-REFERENCE TO RELATED APPLICATIONS

The present application claims the priority benefit of Taiwanese Application No. 110132095, filed on Aug. 30, 2021, which is incorporated by reference herein in its entirety.

### BACKGROUND

The present disclosure relates to a processing circuit, more particularly, to a processor circuit capable of determining an operating voltage of a processor and a related non-transitory computer-readable medium.

A circuit, e.g. a processor circuit or another integrated circuit, will fail when its operating voltage is too low or unstable. In order for the circuit to operate at a proper operating voltage to maintain normal operation, the operating voltage of the circuit is usually set to a minimum allowable voltage plus a voltage margin, which is determined according to manual experimentation and human decision. The voltage margin is usually much greater than what is actually needed to ensure proper operation of the circuit.

However, an excessive voltage margin causes unnecessary power consumption.

### SUMMARY

The described embodiments therefore provide a processor circuit capable of determining an operating voltage of a processor and a related non-transitory computer-readable medium to solve the above problem.

Some embodiments described herein include an exemplary processor circuit. The processor circuit includes a processor, N detection circuits and a neural network circuit. The processor is configured to provide a control signal. The control signal indicates an operational status of the processor. The N detection circuits are configured to detect N different types of variation factors affecting an operating voltage of the processor respectively, and accordingly generate N detection results respectively. N is an integer greater than one. The neural network circuit, coupled to the processor and the N detection circuits, is configured to determine the operating voltage of the processor according to the control signal and the N detection results.

Some embodiments described herein include an exemplary non-transitory computer-readable medium. The non-transitory computer-readable medium stores a program code which, when executed by a processor, causes the processor to: provide a control signal, wherein the control signal indicates an operational status of the processor; detect N different types of variation factors affecting an operating voltage of the processor respectively, and accordingly generate N detection results respectively, wherein N is an integer greater than one; and utilize a neural network model to determine the operating voltage of the processor according to the control signal and the N detection results.

### BRIEF DESCRIPTION OF THE DRAWINGS

Aspects of the present disclosure are best understood from the following detailed description when read with the accompanying figures. It should be noted that, in accordance with the standard practice in the field, various features are not drawn to scale. In fact, the dimensions of the various features may be arbitrarily increased or reduced for clarity of discussion.

FIG. 1 is a block diagram illustrating an exemplary processor circuit in accordance with some embodiments of the present disclosure.

FIG. 2 is a diagram illustrating an implementation of the neural network circuit shown in FIG. 1 in accordance with some embodiments of the present disclosure.

FIG. 3 is a diagram illustrating an implementation of the neuron circuit shown in FIG. 2 in accordance with some embodiments of the present disclosure.

FIG. 4 is a diagram of an implementation of the neural network circuit shown in FIG. 1 in accordance with some embodiments of the present disclosure.

FIG. 5 is a block diagram illustrating an exemplary processor circuit in accordance with some embodiments of the present disclosure.

FIG. 6 is a flow chart of an exemplary method for determining an operating voltage of a processor in accordance with some embodiments of the present disclosure.

### DETAILED DESCRIPTION

The following disclosure provides various embodiments or examples for implementing different features of the present disclosure. Specific examples of components and arrangements are described below to simplify the present disclosure. These are, of course, merely examples and are not intended to be limiting. For example, when an element is referred to as being “connected to” or “coupled to” another element, it may be directly connected to or coupled to the other element, or intervening elements may be present.

In addition, reference numerals and/or letters may be repeated in various examples of the present disclosure. This repetition is for the purpose of simplicity and clarity and does not in itself dictate a relationship between the various embodiments and/or configurations discussed. Furthermore, as could be appreciated, the present embodiments provide many ideas that can be widely applied in various scenarios. The following embodiments are provided for illustration purposes, and shall not be used to limit the scope of the present disclosure.

An operating voltage of a circuit may be affected by various types of variation factors, such as process variations, voltage variations, temperature variations, circuit aging, and/or power supply accuracy variations. With regard to a high-speed circuit such as a processor of a system-on-chip, a high operating speed makes the operating voltage more sensitive to the above-mentioned variation factors. As a result, a greater voltage margin may be desired, resulting in higher power consumption.

In order to reduce power consumption, dynamic voltage and frequency scaling (DVFS) can be used to determine an operating frequency and an operating voltage. However, in a case where the operating frequency and the operating voltage have multiple levels, it is not easy to solve the problem of high power consumption by utilizing the voltage margin which is determined according to manual experimentation and human decision. For example, before mass production of chips, the number of samples taken in manual experiment is limited due to the time required for manual experiment. After mass production of chips, the numbers of frequency levels, voltage levels and test items which can be tested are limited due to test time and test cost. In addition, the power supply and stability of the test bench may be different from the actual product. Thus, the operating voltage of the circuit still needs to be set relatively high based on designer's experiences in order to improve the yield rate.

The proposed operating voltage determination scheme can take into account various variation factors those affect the operating voltage stability of a circuit, and utilize a neural network circuit, or a neural network model, to process detection results corresponding to the variation factors, thereby defining a reasonable operating voltage of the circuit. Compared with relying on designer's experiences to determine an operating voltage, the proposed operating voltage determination scheme can accurately predict/determine a reasonable operating voltage of each circuit (e.g. a processor) with the use of the neural network circuit or the neural network model. In some embodiments, the proposed operating voltage determination scheme may be implemented using, but is not limited to, a physical circuit or firmware. Further description is provided below.

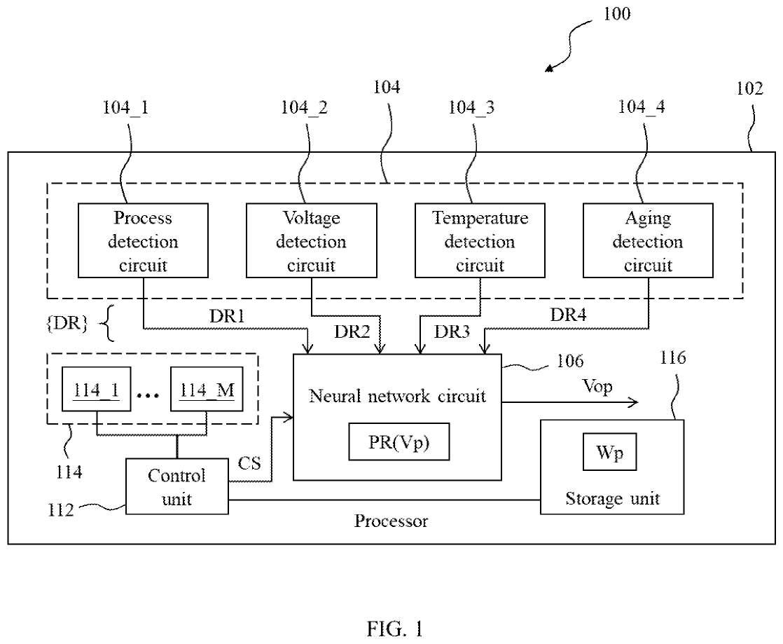

FIG. 1 is a block diagram illustrating an exemplary processor circuit in accordance with some embodiments of the present disclosure. The processor circuit 100 includes, but is not limited to, a processor 102, a detection module 104 and a neural network circuit 106. In the present embodiment, the processor circuit 100 can be implemented as at least a portion of a system-on-chip (SoC). The detection module 104 can be implemented using a detection module in the SoC, and/or the neural network circuit 106 can be implemented using a neural network processor in the SoC. However, this is not intended to limit the scope of the present disclosure.

The processor 102 can be implemented using, but is not limited to, a central processing unit. In the present embodiment, the processor 102 can generate a control signal CS which can indicate an operational status of the processor 102, such as whether one or some computing units of the processor 102 are activated, or a frequency level of the processor 102. By way of example but not limitation, the processor 102 may include a control unit 112 and a computing circuit 114. The control signal CS outputted by the control unit 112 can indicate activated computing unit(s) in the computing units 114_1-114_M (M is a positive integer) which is included in the computing circuit 114. The computing units 114_1-114_M may include, but are not limited to, at least one of an arithmetic logic unit (ALU), a multiply accumulate (MAC) unit, a floating point unit, an instruction fetch unit, an issue dispatch unit and a load/store unit. The control signal CS may be, but is not limited to an enable signal of architecture integrated clock gating (ICG).

The detection module 104 may include N detection circuits, where N is a positive integer greater than one. The N detection circuits can be configured to detect N different types of variation factors affecting an operating voltage Vop of the processor 102, respectively, and accordingly generate N detection results {DR}, respectively. In the present embodiment, the above-mentioned N types of variation factors can include, but are not limited to, at least one of a process variation factor, a voltage variation factor, a temperature variation factor and an aging variation factors. For example, the detection module 104 can be implemented using a process detection circuit 104_1, a voltage detection circuit 1042, a temperature detection circuit 104_3 and an aging detection circuit 104_4 (N=4). In other words, the above-mentioned N types of variation factors can be a process variation factor, a voltage variation factor, a temperature variation factor and an aging variation factor.

The process detection circuit 104_1 is configured to detect process information or a process corner of the processor circuit 100, and accordingly generate a detection result DR1. For example, the process detection circuit 104_1 can detect a frequency of an oscillating signal generated by an oscillator included in the processor circuit 100, such as a ring oscillator (not shown in FIG. 1), thereby generating the detection result DR1. The voltage detection circuit 104_2 is configured to detect a voltage of the processor circuit 100 or detect changes of the voltage, thereby generating a detection result DR2. For example, the voltage detection circuit 104_2 can detect changes of a supply voltage and/or power supply accuracy of the processor circuit 100, thereby generating the detection result DR2. The temperature detection circuit 104_3 is configured to detect a temperature of the processor circuit 100 or changes of the temperature, thereby generating a detection result DR3. The aging detection circuit 104_4 is configured to detect an aging condition of the processor circuit 100, thereby generating a detection result DR4. For example, the aging detection circuit 104_4 can detect changes of the processing speed of the processor circuit 100 after an aging test, thereby generating the detection result DR4.

The neural network circuit 106, coupled to the processor 102 and the detection module 104, is configured to determine the operating voltage Vop according to the control signal CS and the N detection results {DR}. For example, with regard to the detection result DR1, an operating voltage employed by a circuit manufactured using a relatively slow process is usually higher than an operating voltage employed by a circuit manufactured using a relatively fast process. With regard to the detection result DR2, in a case where the processor circuit 100 operating in different operating scenarios (e.g. a light load mode and a heavy load mode) is supplied by the same supply voltage, corresponding voltages appearing within the processor circuit 100 would be different from each other. With regard to the detection result DR3, an operating voltage employed by a circuit operating at a relatively high temperature is usually higher than an operating voltage employed by a circuit operating at a relatively low temperature. With regard to the detection result DR4, an operating voltage usually increases after a high temperature and high voltage aging test. According to an effect of each detection imposed on an operating voltage, the operating voltage Vop having a suitable level can be predicted.

In the present embodiment, the neural network circuit 106 can perform an associated weighting operation on the detection results DR1-DR4 according to the operational status of the processor 102, indicated by the control signal CS, and accordingly predict the appropriate operating voltage Vop. For example, the neural network circuit 106 may include a plurality of sub-circuits acting as a plurality of neurons (not shown) or a plurality of software acting as a plurality of neurons (not shown). The sub-circuits may be referred to as a plurality of neuron circuits. The neural network circuit 106 can determine a set of weight values, which are assigned to each neuron, according to the control signal CS and the detection results DR1-DR4. The neural network circuit 106 can further process the detection results DR1-DR4 according to a plurality of sets of weight values assigned to the neurons, and accordingly generate a processing result PR. Next, the neural network circuit 106 can determine the operating voltage Vop of the processor 102 at least according to the processing result PR.

In operation, the processor circuit 100 may be subjected to a stress test, where the processor circuit 100 operates under a high load condition. The neural network circuit 106 can perform a neural network algorithm according to the control signal CS and the detection results DR1-DR4, thereby adjusting weight value(s) corresponding to neuron(s) of the neural network circuit 106 (not shown FIG. 1). The voltage Vp indicated by the processing result PR of the neural network circuit 106 approaches a stable value. In the present embodiment, by adjusting the weight value(s) corresponding to the neuron(s), the neural network circuit 106 can gradually reduce a voltage indicated by a weight processing result of the detection results DR1-DR4. Accordingly, the voltage Vp indicated by the processing result PR approaches the stable value. The neural network circuit 106 may output the processing result PR to thereby use the voltage Vp as a lowest stable operating voltage of the processor 102, i.e. the operating voltage Vop. With the use of the detection results of the various types of variation factors and the neural network circuit 106, the processor circuit 100 can accurately predict/determine the lowest stable operating voltage of the processor 102, thus avoiding an excessive voltage margin which is reserved based on designer's experiences.

Additionally or alternatively, when the processing result PR is generated, the neural network circuit 106 can store the weight value corresponding to each neuron into a storage unit 116 of the processor 102. Based on weight information Wop stored into the storage unit 116, the circuit designer can obtain a relationship between the operating voltage Vop and various variation factors, which helps to improve the stability and accuracy of the operating voltage Vop.

To facilitate an understanding of the present disclosure, the proposed operating voltage determination scheme is described below with reference to some embodiments of a neural network model. However, those skilled in the art can appreciate the proposed operating voltage determination scheme can be employed to other embodiments of the neural network model without departing from the scope of the present disclosure.

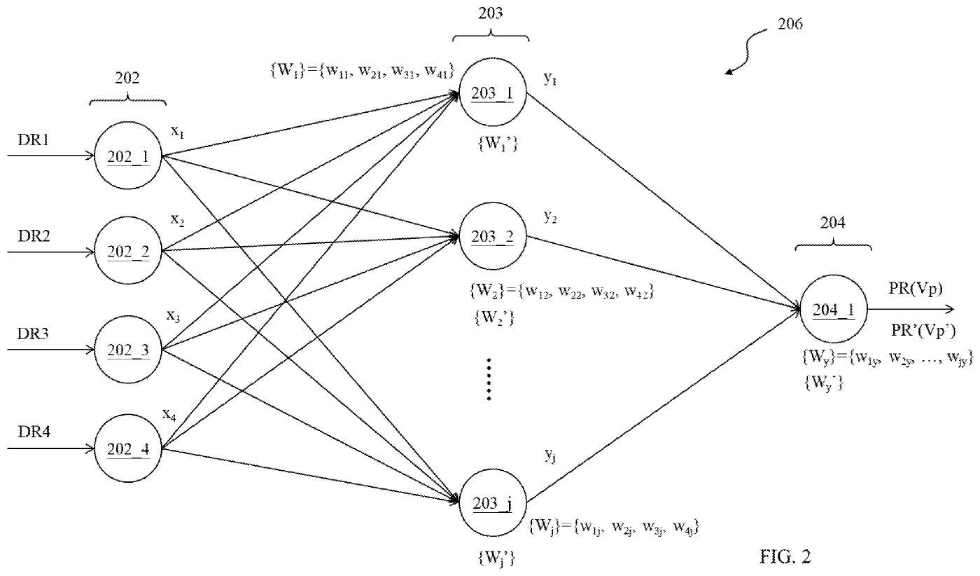

FIG. 2 is a diagram illustrating an implementation of the neural network circuit 106 shown in FIG. 1 in accordance with some embodiments of the present disclosure. The neural network circuit 206 may be implemented using a feedforward neural network model, which includes, but is not limited to, neurons or neuron circuits which can act as an input layer 202, a hidden layer 203, and an output layer 204. For example, a neuron can be implemented by software/firmware. The input layer 202 is configured to receive the detection results DR1-DR4 to generate a plurality of input signals x₁-x₄. The hidden layer 203 is configured to process the input signals x₁-x₄ according to a plurality of sets of weight values, and accordingly generate a plurality of output signals y₁-yⱼ, where j is an integer greater than one. The output layer 204 is configured to determine the operating voltage Vop of the processor 102 shown in FIG. 1 to according to the output signals y₁-yⱼ.

In the present embodiment, the input layer 202 can include a plurality of neuron circuits 202_1-202_4. The neural network circuit 206 can normalize the detection results DR1-DR4 received by the neuron circuits 202_1-202_4 to the input signals x₁-x₄ having signal values within a predetermined range.

The hidden layer 203 can include a plurality of neuron circuits 203_1-203j, and the output layer 204 can include the neuron circuit 204_1. The neural network circuit 206 can determine a plurality of sets of weight values {W₁}-{Wⱼ} assigned to the neuron circuits 203_1-203_j and/or a set of weight values {W_{y}} assigned to the neuron circuit 204_1 according to the control signal CS and the detection results DR1-DR4. The neural network circuit 206 can process the detection results DR1-DR4 according to the sets of weight values {W₁}-{Wⱼ} and {W_{y}} to thereby generate the processing result PR. For example, the input signals x₁-x₄ can be multiplied by a plurality of weight values w₁-w₄₁ included in the set of weight values {W₁}, respectively, and then inputted to the neuron circuit 203_1, the input signals X₁-X₄ can be multiplied by a plurality of weight values w₁₂-w₄₂ included in the set of weight values {W₂}, respectively, and then inputted to the neuron circuit 203_2, and so on. The input signals y₁-yⱼ generated by the hidden layer 203 can be multiplied by plurality of weight values w_{1y}-w_{jy} included in the set of weight values {W_{y}}, respectively, and then inputted to the neuron circuit 204_1. The neuron circuit 204_1 can generate the processing result PR according to the input signals y₁-yⱼ and the weight values w_{1y}-w_{jy}.

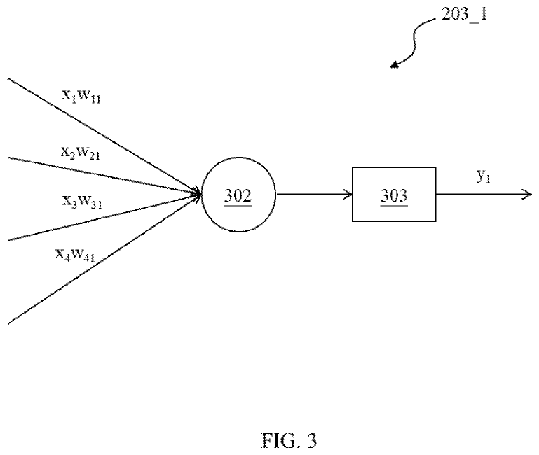

FIG. 3 is a diagram illustrating an implementation of the neuron circuit 203_1 shown in FIG. 2 in accordance with some embodiments of the present disclosure. In the present embodiment, a calculating unit 302 associated with the neuron circuit 203_1, which may be a hardware circuit or a software unit, can use the weight values w₁₁-w₄₁ to perform weighted computation on the input signals x₁-x₄, and add an offset to generate a computation result. A conversion unit 303 associated with the neuron circuit 203_1 can use a transfer function to transmit the computation result to thereby generate the output signal y₁. It is worth noting that each of the neuron circuits 203_2-203_j and 204_1 shown in FIG. 2 can employ the neuron structure shown in FIG. 3.

Referring again to FIG. 2, after generating the processing result PR, the neural network circuit 206 can determine the operating voltage Vop of the processor 102 shown in FIG. 1 at least according to the processing result PR. For example, the neural network circuit 206 can output the processing result PR to thereby use the voltage Vp as the operating voltage Vop shown in FIG. 1. In another example, the neural network circuit 206 can determine whether the voltage Vp indicated by the processing result PR tends to be stable according to a previous weight processing result and the processing result PR, i.e. a current processing result, and accordingly determine the operating voltage Vop shown in FIG. 1.

In the present embodiment, before the weight processing result of the neural network circuit 206 tends to be stable, the neural network circuit 206 can adjust a set of weight values assigned to each neuron circuit one or more times. For example, before determining the operating voltage Vop shown in FIG. 1, the neural network circuit 206 can assign a plurality of sets of weight values {W₁′}-{Wⱼ′} to the neuron circuits 203_1-203_j, and assign a set of weight values {W_{y}′} to the neuron circuit 204_1. The neural network circuit 206 can use the sets of weight values {W₁′}-{Wⱼ′} and {W_{y}′} to process the detection results DR1-DR4 so as to generate the processing result PR′. In addition, the neural network circuit 206 can adjust the sets of weight values {W₁′}-{Wⱼ′} and {W_{y}′} one or more times according to the processing result PR′, thereby generating the sets of weight values {W₁}-{Wⱼ} and {W_{y}}. In a case where the neural network circuit 206 gradually lowers the voltage indicated by the weight processing result, the voltage Vp′ indicated by the processing result PR′ is greater than the voltage Vp indicated by the processing result PR.

In some embodiments, the processing result PR′ and the processing result PR can be two consecutive processing results generated when the neural network circuit 206 performs two consecutive weighting operations on the detection results DR1-DR4. The neural network circuit 206 can determine if the voltage Vp tends to be stable according to the processing result PR′ and the processing result PR. For example, the neural network circuit 206 can determine whether a voltage difference between the voltage Vp and the voltage Vp′ is less than a predetermined value. When the voltage difference between the voltage Vp and the voltage Vp′ is less than the predetermined value, the neural network circuit 206 can determine that the voltage Vp tends toward to be stable, and output the processing result PR to thereby use the voltage Vp is used as the operating voltage Vop shown in FIG. 1.

In some embodiments, the processing result PR′ may be a processing result generated when the neural network circuit 206 performs the weighting operation on the detection results DR1-DR4 for the first time. The neural network circuit 206 can determine the sets of weight values {W₁′}-{Wⱼ′} and {W_{y}′} according to the operational status of the processor 102 shown in FIG. 1. For example, a plurality of sets of weight values, assigned to the neuron circuits 203_1-203j and 204_1 when the control signal CS indicates that the computing unit 114_1 shown in FIG. 1 is activated, is different from a plurality of sets of weight values assigned to the neuron circuits 203_1-203_j and 204_1 when the control signal CS indicates that the computing unit 114_M shown in FIG. 1 is activated.

Further, when the neural network circuit 206 outputs the processing result PR so as to use the voltage Vp as the operating voltage Vop shown in FIG. 1, the neural network circuit 206 can further store the sets of weight values {W₁}-{Wⱼ} and {W_{y}} in the storage unit 116 of the processor 102 shown in FIG. 1. The sets of weight values {W₁}-{Wⱼ} and {W_{y}} can be implemented as at least a portion of the weight information Wp shown in FIG. 1.

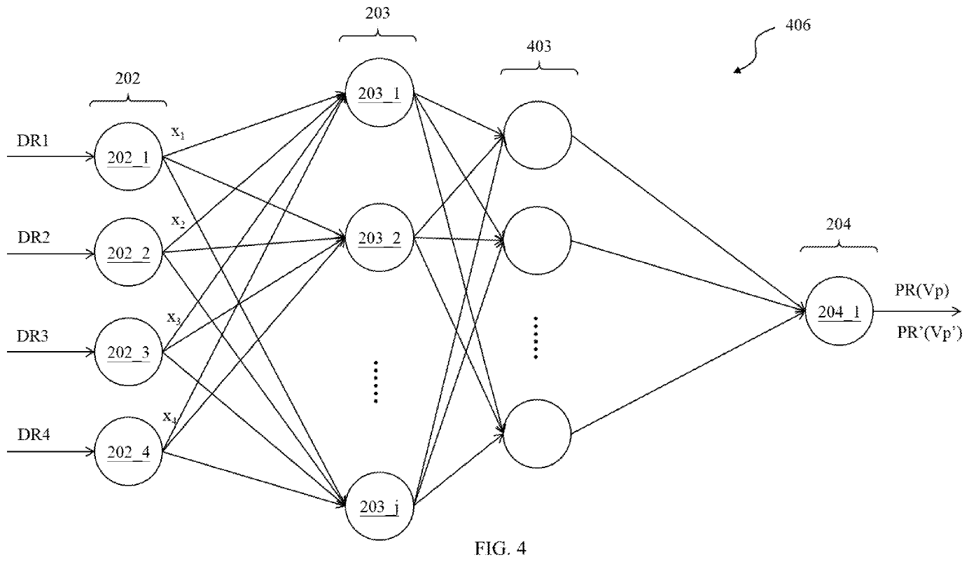

The aforementioned structure of a neural network circuit and/or a neuron circuit is provided for illustrative purposes only, and is not intended to limit the scope of the present disclosure. For example, the neural network circuit 106 shown in FIG. 1 can be implemented using a neural network model including multiple hidden layers. FIG. 4 is a diagram of an implementation of the neural network circuit 106 shown in FIG. 1 in accordance with some embodiments of the present disclosure. The neural network circuit 406 shown in FIG. 4 can be similar/identical to the neural network circuit 206 shown in FIG. 2 except for the hidden layer 403. The hidden layer 403 is configured to perform a weighting operation on an output of the hidden layer 203 to thereby generate an output signal which is inputted to the output layer 204. In addition, the connection between layers (e.g. hidden and output layers), the amount of weight value adjustment, and the number of neurons in each layer, etc., are not intended to limit the scope of the present disclosure. As one skilled in the art can appreciate the operation of the neural network circuit 406 and associated modifications after reading the above paragraphs directed to FIG. 1 to FIG. 3, further description is omitted for the sake of brevity.

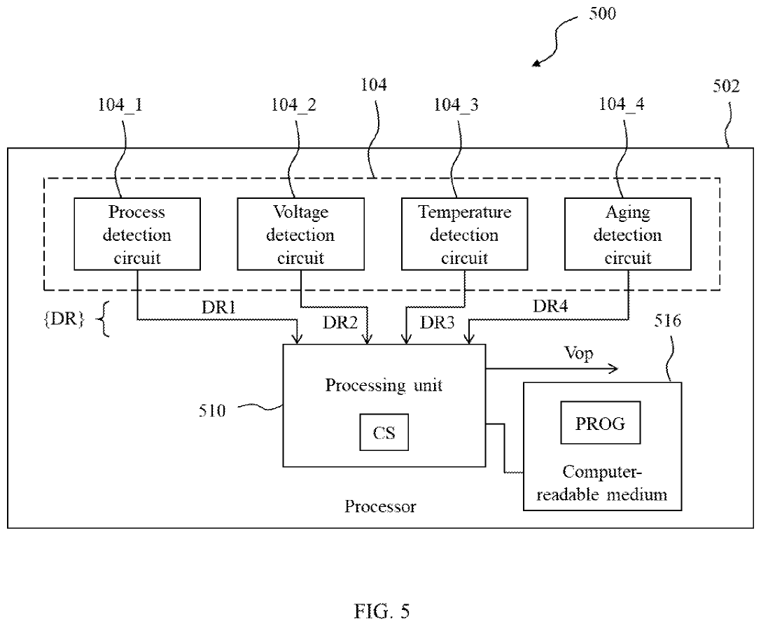

In some embodiments, the proposed operating voltage determination scheme can utilize commands, parameters and variables of a specific program language to translate each step into a program code. FIG. 5 is a block diagram illustrating an exemplary processor circuit in accordance with some embodiments of the present disclosure. The circuit structure of the processor circuit 500 shown in FIG. 5 can be similar/identical to that of the processor circuit 100 shown in FIG. 1 except that the processor circuit 500 is implemented by firmware to provide an operating voltage determination scheme. In the present embodiment, the processor 502 includes a processing unit 510 and a computer-readable medium 516. The processing unit 510 can be an embodiment of the control unit 112 and the computing circuit 114 shown in FIG. 1, and can be implemented using, but is not limited to, a micro control unit. The computer-readable medium 516 can be an embodiment of the storage unit 116 shown in FIG. 1, and can be implemented using, but is not limited to, a non-volatile memory. The computer-readable medium 516 can store a program code PROG. The processing unit 510 can extract and execute the program code PROG to implement the proposed operating voltage determination scheme.

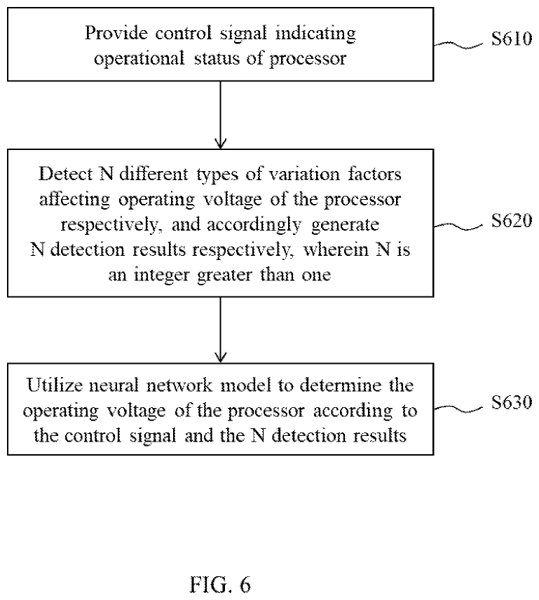

FIG. 6 is a flow chart of an exemplary method for determining an operating voltage of a processor in accordance with some embodiments of the present disclosure. Referring to FIG. 5 and also to FIG. 6, the program code PROG, when executed by the processing unit 510, can cause the processing unit 510 to perform step S610, step S620 and step S630 at least. In step S610, the control signal CS capable of indicating the operational status of the processor 502 is provided. In step S620, N different types of variation factors which affect the operating voltage Vop of the processor 502 are detected, to thereby generate the N detection results {DR} respectively, such as the detection results DR1-DR4. In step S630, a neural network model, which can include a plurality of neurons implemented by, for example, software/firmware, is utilized to determine the operating voltage Vop of the processor 502 according to the control signal CS and the N detection results {DR}. As one skilled in the art can appreciate the operation of the method shown in FIG. 6 and associated modifications after reading the above paragraphs directed to FIG. 1 to FIG. 5, further description is omitted for the sake of brevity.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent embodiments still fall within the spirit and scope of the present disclosure, and they may make various changes, substitutions, and alterations thereto without departing from the spirit and scope of the present disclosure.

What is claimed is:

1. A processor circuit, comprising:
a processor, configured to provide a control signal, wherein the control signal indicates an operational status of the processor;
N detection circuits, configured to detect N different types of variation factors affecting an operating voltage of the processor respectively, and accordingly generate N detection results respectively, N being an integer greater than one; and
a neural network circuit, coupled to the processor and the N detection circuits, the neural network circuit being configured to determine the operating voltage of the processor according to the control signal and the N detection results.

2. The processor circuit of claim 1, wherein the N different types of variation factors comprise at least one of a process variation factor, a voltage variation factor, a temperature variation factor, and an aging variation factor.

3. The processor circuit of claim 1, wherein the neural network circuit comprises a plurality of neuron circuits; the neural network circuit is configured to determine a set of first weight values that is assigned to each neuron circuit according to the control signal and the N detection results, process the N detection results according to a plurality of sets of first weight values those are assigned to the neuron circuits and accordingly generate a first processing result, and determine the operating voltage of the processor at least according to the first processing result.

4. The processor circuit of claim 3, wherein the neural network circuit is configured to assign a plurality of sets of second weight values to the neuron circuits, generate a second processing result by utilizing the sets of second weight values to process the N detection results, and generate the sets of first weight values those are assigned to the neuron circuits by adjusting the sets of second weight values according to the second processing result.

5. The processor circuit of claim 4, wherein the first processing result indicates a first voltage, and the second processing result indicates a second voltage greater than the first voltage.

6. The processor circuit of claim 4, wherein the neural network circuit is configured to determine whether a voltage difference between a first voltage indicated by the first processing result and a second voltage indicated by the second processing result is less than a predetermined value; when the voltage difference between the first voltage and the second voltage is less than the predetermined value, the neural network circuit is configured to output the first processing result, and accordingly use the first voltage as the operating voltage.

7. The processor circuit of claim 4, wherein the neural network circuit is configured to determine the sets of second weight values according to the operational status of the processor indicated by the control signal.

8. The processor circuit of claim 7, wherein the sets of second weight values assigned to the neuron circuits when the control signal indicates that a computing unit of the processor is activated is different from the sets of second weight values assigned to the neuron circuits when the control signal indicates that another computing unit of the processor is activated.

9. The processor circuit of claim 3, wherein the neural network circuit is configured to normalize the N detection results to N input signals having signal values within a predetermined range, and generate the first processing result by processing the N input signals according to the sets of first weight values.

10. The processor circuit of claim 3, wherein when the neural network circuit is configured to output the first processing result and accordingly use the voltage indicated by the first processing result as the operating voltage, the neural network circuit is further configured to store the sets of first weight values in a storage unit of the processor.

11. A non-transitory computer-readable medium storing a program code which, when being executed by a processor, causes the processor to:
provide a control signal, wherein the control signal indicates an operational status of the processor;
detect N different types of variation factors affecting an operating voltage of the processor respectively, and accordingly generate N detection results respectively, N being an integer greater than one; and
utilize a neural network model to determine the operating voltage of the processor according to the control signal and the N detection results.

12. The non-transitory computer-readable medium of claim 11, wherein the N different types of variation factors comprise at least one of a process variation factor, a voltage variation factor, a temperature variation factor, and an aging variation factor.

13. The non-transitory computer-readable medium of claim 11, wherein the neural network model comprises a plurality of neurons; the step of determining the operating voltage of the processor according to the control signal and the N detection results comprises:
determining a set of first weight values that is assigned to each neuron according to the control signal and the N detection results;
processing the N detection results according to a plurality of sets of first weight values those are assigned to the neurons, and accordingly generating a first processing result; and
determining the operating voltage of the processor at least according to the first processing result.

14. The non-transitory computer-readable medium of claim 13, wherein the step of determining the set of first weight values that is assigned to each neuron according to the control signal and the N detection results comprises:
assigning a plurality of sets of second weight values to the neurons;
generating a second processing result by utilizing the sets of second weight values to process the N detection results; and
generating the sets of first weight values those are assigned to the neurons by adjusting the sets of second weight values according to the second processing result.

15. The non-transitory computer-readable medium of claim 14, wherein the first processing result indicates a first voltage, and the second processing result indicates a second voltage greater than the first voltage.

16. The non-transitory computer-readable medium of claim 14, wherein the step of determining the operating voltage of the processor at least according to the first processing result comprises:
determining whether a voltage difference between a first voltage indicated by the first processing result and a second voltage indicated by the second processing result is less than a predetermined value; and
when the voltage difference between the first voltage and the second voltage is less than the predetermined value, outputting the first processing result to use the first voltage as the operating voltage.

17. The non-transitory computer-readable medium of claim 14, wherein the step of determining the set of first weight values assigned to each neuron according to the control signal and the N detection results further comprises:
determining the sets of second weight values according to the operational status of the processor indicated by the control signal.

18. The non-transitory computer-readable medium of claim 17, wherein the sets of second weight values assigned to the neurons when the control signal indicates that a computing unit of the processor is activated is different from the sets of second weight values assigned to the neurons when the control signal indicates that another computing unit of the processor is activated.

19. The non-transitory computer-readable medium of claim 13, wherein the step of processing the N detection results according to the sets of first weight values assigned to the neurons and accordingly generating the first processing result comprises:
normalizing the N detection results to N input signals having signal values within a predetermined range; and
generating the first processing result by processing the N input signals according to the sets of first weight values.

20. The non-transitory computer-readable medium of claim 13, wherein the program code, when being executed by the processor, further causes the processor to:
store the sets of first weight values in a storage unit of the processor when a voltage indicated by the first processing result serves as the operating voltage.
